(19) United States
(12) Patent Application Publication
(10) Pub. No.: US 2004/0066795 A1
(43) Pub. Date: Apr. 8, 2004

(54) Determination of code transmit power range in downlink power control for cellular systems

(75) Inventor: Guodong Zhang, Patchogue, NY (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/677,717

(22) Filed: Oct. 2, 2003

Related U.S. Application Data
(60) Provisional application No. 60/415,938, filed on Oct. 3, 2002.

(51) Int. Cl. H04B 7/212

(52) U.S. Cl. 370/442; 370/337

(57) ABSTRACT

A method and apparatus employing algorithms enabling cellular networks to determine the range of code transmit power in downlink, as well as uplink, power control. Two exemplary algorithms provide a determination of an appropriate transmit power range for each code so that when the transmit power of any code approaches an upper limit, the transmit power of the other codes can be adjusted to catch up with the dynamic range. Even though the two exemplary algorithms have functional similarities, in the second algorithm, the frequency of reconfiguration of code transmit power range is much less than the frequency of change of the number of codes. Both algorithms are applicable for use in all modes of transmission in UMTS systems.

This application claims priority from U.S. Provisional Application No. 60/415,938 and filed on Oct. 3, 2002, which is incorporated by reference as if fully set forth herein.

### FIELD OF THE INVENTION

This invention generally relates to cellular networks and more particularly to determination of code transmit power for use in power control.

### BACKGROUND OF THE INVENTION

For a Universal Mobile Telecommunication System (UMTS) system, in the downlink there are a plurality of different codes transmitted for a plurality of different coded Composite Transport Channels (CCTrCHs) transmitting. Each CCTrCH is power controlled independently. At the receiver of the UE (a RAKE receiver is used for frequency division duplex (FDD), a multi-user detector (MUD) receiver is used for time division duplex (TDD)), the difference between the transmit power of two codes in the same cell has to be within a certain range to assure that the receiver works properly. The maximum allowed difference is called the dynamic range of the receiver. Because the total transmit power (i.e., carrier power) in the downlink is limited, an appropriate range of transmit power for each code should be determined to allow the power control to adjust the difference of code transmit powers to be in the dynamic range as much as possible.

Currently, there is no known convenient algorithm to determine the range of transmit power for each code in the downlink. The consequence of this is that the transmit power of one code can be increased to a very high value by the power control, which makes it difficult for the transmit power of other codes to catch up with the dynamic range due to the limit of Node B total transmitter power.

It is desirable to provide a method for determining the range of transmit power in the downlink, preferably in the form of an algorithm.

### SUMMARY OF THE INVENTION

The invention provides a method and apparatus employing an algorithm for determining the range of transmit power for each code in the downlink properly for all modes of UMTS systems (including FDD, high chip rate (HCR) TDD, and low chip rate (LCR) TDD). In a preferred embodiment, the invention provides details of the preferred implementation. While the following description makes reference to downlink power control for CDMA systems as an example, it is to be noted that the invention is applicable for uplink power control and is also usable in cellular systems other than those mentioned above.

### BRIEF DESCRIPTION OF THE DRAWINGS

A more detailed understanding of the invention may be had from the following description of preferred embodiments, given by way of example and to be understood in conjunction with the accompanying drawing wherein:

FIG. 1 illustrates diagrammatically a first embodiment in the form of a flow chart for determination of code transmit power range in downlink; and

FIG. 2 illustrates diagrammatically a second embodiment in the form of a flow chart.

The following acronyms are used in the present application:

AWGN additive white Gaussian noise

BLER block error rate

CCTrCH coded composite transport channel

CDMA code-division multiple access

CRNC controlling RNC

DR dynamic range

FDD frequency-division duplex

HCR high chip rate

LCR low chip rate

MUD multi-user detector

RNC radio network controller

SIR signal to interference ratio

TDD time-division duplex

UE user equipment

UMTS universal mobile telecommunications system

### DETAILED DESCRIPTION OF PREFERRED EMBODIMENTS

Described hereinafter are a method and apparatus employing algorithms in one of the first and second embodiments for determination of code transmit power for downlink power control in cellular networks. The transmit power range lies between the upper bound and lower bound of the transmit power of a particular code. The method of the present invention determines an appropriate transmit power range (especially the upper bound) for each code so that when the transmit power of any code approaches its upper bound, the transmit power of other codes can be adjusted to stay within the dynamic range.

The solution of two present inventions determines the range of code transmit power using at least some of the following parameters: 1) number of codes in the downlink (time slot, if TDD); 2) the range of the SIR target of the code; 3) the maximum allowed dynamic range of the receiver used at the UE (dynamic power range of the receiver is the maximum allowed difference between transmit power of any codes); 4) average MUD efficiency factor in the downlink (for TDD only); 5) average orthogonal factor in the downlink (for FDD only); 6) average inter-cell to intra-cell interference ratio.

The inventive method permits cellular networks to determine the dynamic range of code transmit power in the downlink power control. In particular, it is applicable to all modes of UMTS systems (including FDD, HCR TDD, and LCR TDD).

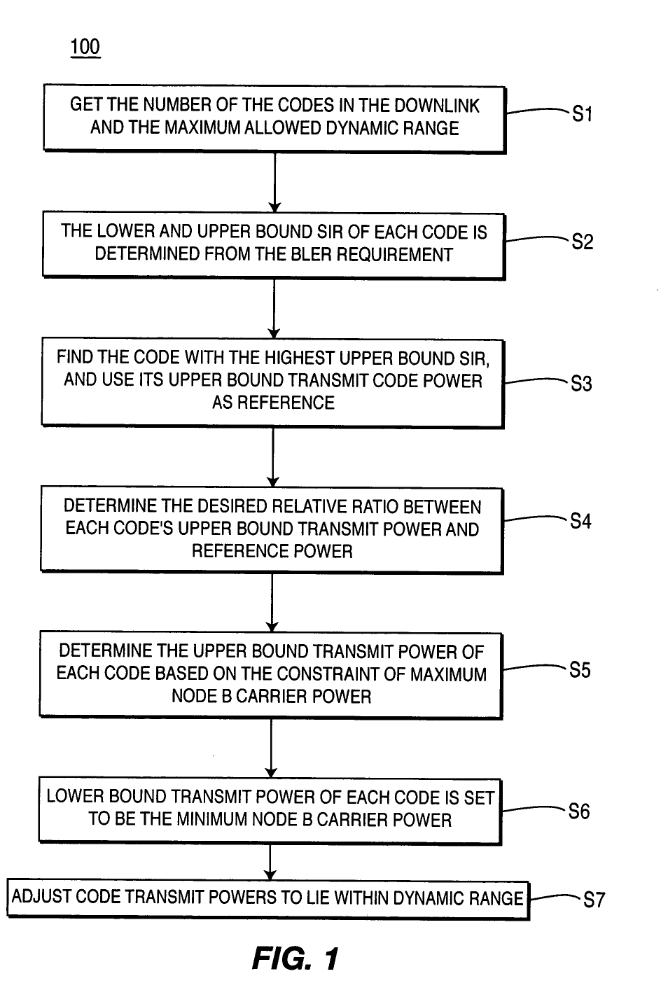

The method 100 of the first embodiment, shown in FIG. 1, uses the following information to determine the range of code transmit-power:

The number of codes in the downlink (time slot, if TDD), denoted by N, at step S1 is obtained;

The range of the SIR target of the code i: the lower bound SIR_{lb} (i) and upper bound SIR_{ub} (i), is then obtained (step S2). The range is determined by the C-RNC from the BLER requirement of service and possible propagation conditions. For example, the upper bound is the SIR target corresponding to the SIR in the worst case (known as case 1 in the technical literature) and the lower bound is the SIR target corresponding to the best case (known as the AWGN case in the technical literature); and

The maximum allowed dynamic range of the receiver used at the UE is DR, the value of which depends on the design of the receiver. Therefore, DR is a design parameter that can be configured by the operator.

The code transmit power range is determined as follows. First, among all the codes, the code with maximum upper bound SIR target, say code j, is selected (step S3). The upper bound of the transmit power of code i is denoted by TXCode_{ub} (i) which is used as a reference. The relationship between the upper bound of code transmit power of code i and code j (the code with maximum upper bound SIR target), obtained at step S4, is expressed as:

TXCode_{ub} (i)=R(i)·TXCode_{ub} (j) Equation 1

where R(i), the desired ratio between TXCode_{ub} (i) and TXCode_{ub} (j), is

$$R ( i ) = \{ \begin{matrix}\frac{{SIR}_{ub} ( i )}{{SIR}_{ub} ( j )} & if & \frac{{SIR}_{ub} ( j )}{{SIR}_{ub} ( i )} \leq DR \\ \frac{1}{DR} & if & \frac{{SIR}_{ub} ( j )}{{SIR}_{ub} ( i )} > DR\end{matrix} \qquad Equation 2$$

The sum of upper bound of code transmit power is subject to the limit of maximum Node B carrier power, CATXₘₐₓ, (step S5). For system stability purposes, a margin is used to prevent the total code transmit-power to reach the maximum allowed value. The margin, a design parameter, can be configured by the operator as:

$${\sum }_{i = 1}^{N} {TXCode}_{ub} ( i ) = {CATX}_{max} / Margin \qquad Equation 3$$

Therefore, the upper bound of the transmit power of code i is given by

$${TXCode}_{ub} ( i ) = \frac{R ( i )}{{\sum }_{i = 1}^{N} R ( i )} ( {CATX}_{max} / Margin ) \qquad Equation 4$$

The lower bound of code transmit power, obtained at step S6, is set to the minimum allowed carrier power of the Node B.

TXCode_{lb} (i)=CATXₘᵢₙ Equation 5

The code transmit powers are then adjusted to lie within the dynamic range (step S7). The method 100 will configure or reconfigure the range of code transmit power whenever the number of codes in the downlink changes, which includes: radio link setup for a new CCTrCH and radio link release for an existing CCTrCH. Accordingly, the method 100 is suitable for a real-time services scenario, where the number of codes changes relatively slowly.

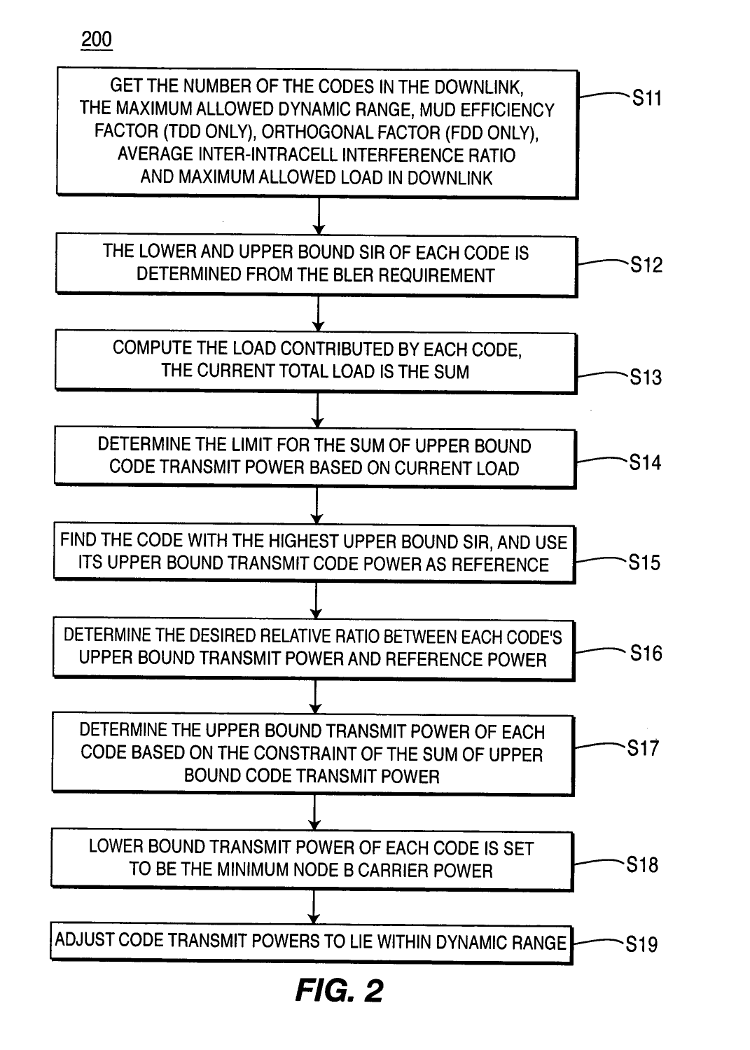

A second embodiment of a method 200 in accordance with the present invention, shown in FIG. 2, uses the following information to determine the range of code transmit power: 1) the number of codes in the downlink (time slot, if TDD), denoted by N; 2) the range of SIR target of the code i: the lower bound SIR_{lb} (i) and upper bound SIR_{ub} (i) which are determined from the BLER requirement; 3) the maximum allowed dynamic range of receiver used at the UE, DR; 4) average MUD efficiency factor in the downlink (for TDD only), α; 5) average orthogonal factor in the downlink (for FDD only), α; 6) average inter-cell to intra-cell interference ratio, η; and 7) maximum allowed load in the downlink, Loadₘₐₓ. This is a design parameter that can be configured by the operator and executed by the call admission control function. These data are obtained at steps S11 and S12.

Code transmit power range is then determined as follows: The current load in the downlink (time slot, if TDD) is computed (S13). Among all the codes, the code with maximum upper bound SIR target, say code j, is selected (step S14).

The load contributed by each code i is given by:

$$\begin{matrix}Load ( i ) = ( 1 - α + η ) \cdot {SIR}_{ub} ( i ) , if \frac{{SIR}_{ub} ( j )}{{SIR}_{ub} ( i )} \leq DR , & Equation 6 \\ Load ( i ) = ( 1 - α + η ) \cdot ( {SIR}_{ub} ( j ) / DR ) , \\ if \frac{{SIR}_{ub} ( j )}{{SIR}_{ub} ( i )} > DR . & Equation 7\end{matrix}$$

Therefore, the total load is given by:

$$Load = {\sum }_{i = 1}^{N} Load ( i ) \qquad Equation 8$$

The load in the downlink is controlled by the call admission control function to be no more than the maximum allowed load in the downlink, Loadₘₐₓ. The limit for the sum of code transmit power upper bounds, obtained at step S14, is set to be proportional to the current load. That is:

$$\begin{matrix}{\sum }_{i = 1}^{N} {TXCode}_{ub} ( i ) = {CATX}_{max}^{′} / Margin , where & Equation 9 \\ {CATX}_{max}^{′} = \frac{Load}{{Load}_{max}} \cdot {CATX}_{max} & Equation 10\end{matrix}$$

The upper bound of the transmit power of code i is TXCode_{ub} (i). The relationship between the upper bound of code transmit power of code i and code j (the code with the maximum upper bound SIR target, obtained at step S15), is expressed as:

TXCode_{ub} (i)=R(i)·TXCode_{ub} (j) Equation 11

Where R(i), the desired ratio between TXCode_{ub} (i) and TXCode_{ub} (j), (obtained at step S16), is:

$$R ( i ) = \{ \begin{matrix}\frac{{SIR}_{ub} ( i )}{{SIR}_{ub} ( j )} & if & \frac{{SIR}_{ub} ( j )}{{SIR}_{ub} ( i )} \leq DR \\ \frac{1}{DR} & if & \frac{{SIR}_{ub} ( j )}{{SIR}_{ub} ( i )} > DR\end{matrix} \qquad Equation 12$$

Therefore, the upper bound of transmit power of code i, (obtained at step

$${TXCode}_{ub} ( i ) = \frac{R ( i )}{{\sum }_{i = 1}^{N} R ( i )} ( {CATX}_{max}^{′} / Margin ) \qquad Equation 13$$

Utilizing equation 12 in equations 6-8, the result is:

$$Load = ( 1 - α + η ) \cdot {SIR}_{ub} ( j ) \cdot {\sum }_{i = 1}^{N} R ( i ) \qquad Equation 14$$

Likewise, utilizing equation 14 in equation 10 provides:

$${CATX}_{max}^{′} = \frac{( 1 - α + η ) \cdot {SIR}_{ub} ( j ) \cdot {\sum }_{i = 1}^{N} R ( i )}{{Load}_{max}} \cdot {CATX}_{max} \qquad Equation 15$$

Finally, utilizing 15 in equation 13 yields:

$${TXCode}_{ ub} ( i ) = \frac{( 1 - α + η ) \cdot R ( i ) \cdot SIR ( j )}{{Load}_{ max}} \cdot \frac{{CATX}_{ max}}{Margin} \qquad Equation 16$$

The lower bound of the code transmit power (obtained at step S18), is set to be the minimum allowed carrier power of the Node B as:

TXCode_{lb} (i)=CATXₘᵢₙ Equation 17

The code transmit powers are then adjusted to lie within the dynamic range (step S19).

The method 200 shown in FIG. 2 does not necessarily need to configure or reconfigure the range of code transmit power when the number of codes in the downlink changes. As shown in equation 16, the transmit power range for a code is determined by its SIR upper bound and maximum SIR upper bound of codes in the downlink (time slot, if TDD). As long as the maximum SIR upper bound of codes in the downlink (time slot, if TDD) does not change the value of R(i) SIR_{ub} (j), the range of code transmit power will not change. As a result, the frequency of reconfiguration of the code transmit power range is much less than the frequency at which the number of codes changes. Therefore, this algorithm is suitable for a non-real-time services scenario, where the number of codes changes quickly. In addition, it is also suitable for a real-time services scenario as well.

The flow diagram of FIG. 1 shows the preferred sequence of operations for implementing the first algorithm. Initially, the number of the codes in the downlink and the maximum allowed dynamic range are obtained, followed by steps which operate on the data obtained to achieve the desired result. However, the steps may be altered in sequence without departing from the scope of the invention.

The flow diagram of FIG. 2 shows the preferred sequence of operations for implementing the second algorithm. The process initially obtains the number of codes in the downlink, the maximum allowed dynamic range, MUD efficiency factor (as applied to TDD only), orthogonal factor (as applied to FDD only), average inter-intracell interference ratio, and maximum allowed load in downlink, followed by operations on these data to achieve the desired result. Here too, the steps may be altered in sequence without departing from the scope of the invention.

Even though the above description makes reference to FDD and TDD systems as examples, the invention for downlink power control is applicable to other types of communication systems as well.

What is claimed is:

1. A method for determining code transmit power in a time division duplex communication system, comprising:
a) obtaining a number of codes in a downlink and a maximum allowed dynamic range;
b) determining an upper bound and a lower bound of a signal to interference ratio (SIR) of each code based on a block error rate (BLER) requirement;
c) computing a load contributed by each code;
d) summing the load to obtain a current total load;
e) determining a limit for a sum of upper bound code transmit power based on a current load;
f) determining a code with the highest upper bound SIR;
g) employing the upper bound code transmit power of the code having the highest upper bound SIR;
h) determining a desired relative ratio between the upper bound code transmit power of each code and a reference;
i) determining the upper bound transmit power of each code based on a sum of the upper bound code transmit power; and
j) setting a lower bound transmit power for each code based on a minimum Node B carrier power.

2. The method of claim 1, further comprising:
adjusting code transmit powers to lie within a dynamic range.

3. The method of claim 1, wherein step (a) further comprises:
obtaining a multi-user detector (MUD) efficiency factor and average inter-intracell interference ratio and a maximum allowed load in downlink.

4. The method of claim 1, wherein step (b) further includes selecting an SIR target corresponding to an SIR in a worst case as the upper bound.

5. The method of claim 1, wherein step (b) further includes selecting an SIR target corresponding to an SIR in a best case.

6. A method for determining code transmit power in a frequency division duplex communication system, comprising:
a) obtaining a number of codes in a downlink and a maximum allowed load in the downlink;
b) determining an upper bound and a lower bound of a signal to interference ratio (SIR) of each code based on a block error rate (BLER) requirement;
c) computing a load contributed by each code;
d) summing the load to obtain a current total load;
e) determining a limit for a sum of upper bound code transmit power based on a current load;
f) determining a code with a highest upper bound SIR;
g) employing the upper bound code transmit power of the code having the highest upper bound SIR;
h) determining a desired relative ratio between the upper bound code transmit power of each code and a reference;
i) determining the upper bound transmit power of each code based on a sum of the upper bound code transmit power; and
j) setting a lower bound transmit power for each code based on a minimum Node B carrier power.

7. The method of claim 6, further comprising:
adjusting code transmit powers to lie within a dynamic range.

8. The method of claim 6, wherein step (a) further comprises:
obtaining a maximum allowed dynamic range, an orthogonal factor, and an average inter-intracell interference ratio.

9. The method of claim 6, wherein step (b) further includes selecting an SIR target corresponding to an SIR in a worst case as the upper bound.

10. The method of claim 6, wherein step (b) further includes selecting an SIR target corresponding to an SIR in a best case.

11. A method for determining code transmit power, comprising:
a) obtaining a number of codes in a downlink in a maximum allowed dynamic range;
b) determining a lower bound and an upper bound signal-to-interference ratio (SIR) of each code based on a block error rate (BLER) criteria;
c) determining a code with a highest upper bound SIR and establishing its upper bound transmit code power as a reference;
d) determining a desired relative ratio between each code upper bound transmit power and the reference;
e) determining an upper bound transmit power of each code based on a constraint of a maximum Node B carrier power; and
f) setting a lower bound transmit power for each code at a minimum Node B carrier power.

12. The method of claim 11, wherein step (b) further includes selecting an SIR target corresponding to an SIR in a worst case as the upper bound.

13. The method of claim 11, wherein step (b) further includes selecting an SIR target corresponding to an SIR in a best case.

14. Apparatus for determining code transmit power in a time division duplex communication system comprising:
means for obtaining a number of codes in a downlink and a maximum allowed load in the downlink;
means for determining an upper bound and a lower bound of a signal to interference ratio (SIR) of each code based on a block error rate (BLER) requirement;
means for computing a load contributed by each code;
means for summing the load to obtain a current total load;
means for determining a limit for a sum of upper bound code transmit power based on the current load;
means for determining a code with the highest upper bound SIR;
means for employing the upper bound code transmit power of the code having the highest upper bound SIR;
means for determining a desired relative ratio between each code upper bound transmit power and a reference;
means for determining an upper bound transmit power of each code based on a sum of the upper bound code transmit power; and
means for setting a lower bound transmit power for each code based on a minimum Node B carrier power.

15. The apparatus of claim 14, further comprising:
means for adjusting the code transmit powers to lie within a dynamic range.

16. The apparatus of claim 14, wherein said means for obtaining further comprises:
means for obtaining a maximum allowed dynamic range, a multiple user detector (MUD) efficiency factor, and an average inter-intracell interference ratio.

17. Apparatus for determining code transmit power in a frequency division duplex communication system, comprising:
means for obtaining a number of codes in a downlink and a maximum allowed load in downlink;
means for determining an upper bound and a lower bound of a signal to interference ratio (SIR) of each code based on a block error rate (BLER) requirement;
means for computing a load contributed by each code;
means for summing the load to obtain a current total load;
means for determining a limit for a sum of upper bound code transmit power based on the current load;
means for determining a code with the highest upper bound SIR;
means for employing the upper bound code transmit power of the code having the highest upper bound SIR;
means for determining a desired relative ratio between the code upper bound transmit power of each code and a reference;
means for determining the upper bound transmit power of each code based on a sum of the upper bound code transmit power; and
means for setting a lower bound transmit power for each code based on a minimum Node B carrier power.

18. The apparatus of claim 17, further comprising:
means for adjusting the code transmit powers to lie within a dynamic range.

19. The apparatus of claim 17, wherein said means for obtaining further comprises:
means for obtaining a maximum allowed dynamic range, an orthogonal factor and an average inter-intracell interference ratio.

20. Apparatus for determining code transmit power, comprising:
means for obtaining a number of codes in a downlink in a maximum allowed dynamic range;
means for determining a lower bound and an upper bound signal-to-interference ratio (SIR) of each code based on a block error rate (BLER) criteria;
means for determining the code with a highest upper bound SIR and establishing its upper bound transmit code power as a reference;
means for determining a desired relative ratio between the upper bound code transmit power of each code and the reference;
means for determining an upper bound transmit power of each code based on a constraint of a maximum Node B carrier power; and
means for setting a lower bound transmit power for each code at a minimum Node B carrier power.
